(19) United States
(12) Patent Application Publication
(10) Pub. No.: US 2025/0328614 A1
(43) Pub. Date: Oct. 23, 2025

(54) IDENTIFYING A CONTEXT OF A USER AUTHENTICATION

(71) Applicant: Fortinet, Inc., Sunnyvale, CA (US)

(72) Inventor: Mark Gregory Caldwell, High Wycombe (GB)

(73) Assignee: Fortinet, Inc., Sunnyvale, CA (US)

(21) Appl. No.: 19/182,902

(22) Filed: Apr. 18, 2025

(30) Foreign Application Priority Data
Apr. 23, 2024 (GB) 2405707.7

(51) Int. Cl. G06F 21/31; G06F 21/62

(52) U.S. Cl. CPC G06F 21/31; G06F 21/6263

(57) ABSTRACT

Systems and methods for identifying a context of a user authentication are provided. In one example, during a user authentication to a web service by a web browser, one or more updates to a state of the web browser are determined. The one or more updates to the state of the web browser are reported to an assessment entity, which may be implemented within an agent external to the web browser. The assessment entity then identifies a context of the user authentication based on the one or more updates to the state of the web browser.

### CROSS REFERENCE TO RELATED APPLICATIONS

This patent application is related to and, under 35 U.S.C. 119, claims the benefit of and priority to Great Britain Patent Application No. 2405707.7, entitled IDENTIFYING A CONTEXT OF A USER AUTHENTICATION, by Mark Gregory Caldwell, filed Apr. 23, 2024, which is hereby incorporated by reference in its entirety for all purposes.

### FIELD

Various embodiments of the present disclosure relate to identifying a context of a user authentication, for example when a user authenticates to a web service at a web browser.

### BACKGROUND

Organizations implementing networks of computing devices may have cyber security solutions in place, including firewalls, network security appliances and antivirus solutions. However, such measures cannot necessarily manage insider risks. Intentional, or unintentional but damaging, actions by users of computing devices in a network can be a serious vulnerability to organizations that traditional tools may not be able to defend against.

Common identity management (CIM) tools cannot necessarily prevent a malicious insider with credentials from performing damaging actions, as they may lack certain context. For example, sensitive data can be hosted on servers with access control rules, but they cannot quantify how it is affected by users' poor cyber hygiene practices. They also generally cannot track the effectiveness of their security controls and training.

Rules defined in security policies that are implemented by entities in a network can be an efficient way to detect real-world insider risk scenarios. For example, policies may be defined so as to permit the detection of users performing certain actions (e.g., using restricted administrative tools, sending sensitive information outside of the organization, circumventing security restrictions, or suspiciously printing documents during unusual hours).

When such activities by users are detected at a local device, a security event can be raised which can be reported from the local device to a remote monitoring entity, and/or action can be taken to block the operation of applications on which suspicious behavior has been detected. Raised security events are typically assessed against security policies at an agent running on a computer.

Data loss prevention solutions can also be used to track data movement to web services. Knowing the domain or uniform resource locator of the service typically may not provide sufficient context to implement meaningful data loss protection controls. For example, cloud storage web services may be used with multiple accounts, allowing data movement between corporate managed storage locations and unmanaged personal storage locations. It is desirable to develop an approach that can overcome such issues.

### BRIEF DESCRIPTION OF THE FIGURES

Embodiments of the present disclosure will now be described by way of example with reference to the accompanying drawings.

In the drawings:

FIG. 1 schematically illustrates a network of computing devices in accordance with an embodiment of the present disclosure.

FIG. 2 shows an example of implementation where a computer is configured to implement a web browser whereby a user can be authenticated to a web server in accordance with an embodiment of the present disclosure.

FIG. 3 shows an example of a method for implementation at a computing device in accordance with an embodiment of the present disclosure.

### DETAILED DESCRIPTION

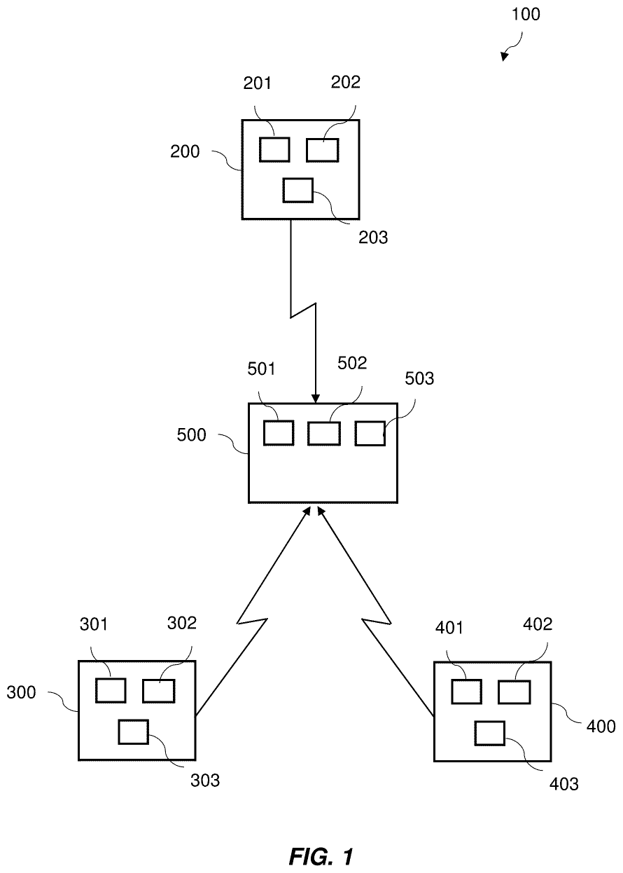

FIG. 1 schematically illustrates a network 100 comprising multiple data processing systems. In this example, the data processing systems are computing devices 200, 300, 400. Each computing device may be, for example, a desktop computer, laptop computer, tablet, mobile phone and/or server computer or a combination thereof. Other suitable computing devices may also be implemented in such a network. The devices may be connected in the network by wired and/or wireless connections. The network may, for example, be a corporate network. Access to the network may be restricted, for example by security devices that filter traffic at the boundary of the network. The network may interface via such security devices to a publicly accessible network (e.g., the internet).

Computing devices 200, 300, 400 each comprise a processor 201, 301, 401 and a memory 202, 302, 402. The processor 201, 301, 401 may be implemented as dedicated hardware. Alternatively, the processor 201, 301 401 may be implemented as a computer program running on a programmable device (e.g., a central processing unit (CPU)). The respective memory 202, 302, 402 is arranged to communicate with the respective processor 201, 301, 401. Memory 202, 302, 402 may be a non-volatile memory. Each device 200, 300, 400 may comprise more than one processor and more than one memory. The memory may store data (i.e. the memory is a data carrier) that is executable by the processor. By executing program code contained in such data, the one or more processors may perform functions as described herein. The memory may store such program code in a non-transitory manner. The processor may be configured to operate in accordance with a computer program stored in non-transitory form on a machine-readable storage medium. The computer program may store instructions for causing the processor to perform its methods in the manner described herein.

Each computing device 200, 300, 400 can support a local software entity or agent. The software entity is able to collect information relating to the computing device and/or a user thereof. There may be one or more users authenticated to the computing device 200. The computing device supports the agent by storing and executing program code which, when executed, implements the agent. In this example the agent is a software entity. The agent may be implemented by one or more principal processors of the computing device, which processor(s) also implement functions of the computing device that implement the computing device's core functions. For example, if the computing device is a desktop computer, its core functions may include sending and receiving email and performing word processing tasks. Thus the principal processors may divide their time between implementing the agent and implementing other functions. Alternatively a dedicated processor may implement the agent.

The agent may be implemented as a user space application program. As used herein, user space applications are applications running in the user space, which is the memory area and a hardware privilege level of a data processing system where, for example, application software and some drivers may execute. The user space may be a limited part of the total memory of the data processing system (e.g. computing device). A user space application may have a corresponding user interface (UI) whereby a user can interact with the application. For example, the user may provide input to the application via the UI. In contrast to user space, kernel space (or supervisor mode) is memory area and hardware privilege level of the data processing system reserved for running an operating system kernel. The user space may correspond to an area of memory and/or a set of privileges that are distinct from an area of memory and/or a set of privileges that are associated with an operating system kernel.

In addition to implementing the agent, the computing device may also implement other user space applications. The computing device may implement one or more user space applications that are not the agent.

Each device 200, 300, 400 may also comprise a transceiver 203, 303, 403 which allows the respective device to communicate with a remote monitoring entity at the central infrastructure apparatus 500.

Central infrastructure apparatus 500 also comprises a processor 501, a memory 502 and a transceiver 503. Processor 501 and memory 502 may operate as described above with reference to processor 201 and memory 202. The apparatus 500 may comprise more than one processor and more than one memory. Transceiver 503 may send or receive data to or from the transceivers 203, 303, 403 of any of the computing devices 200, 300, 400 in the network. The apparatus 500 may be communicatively coupled to a user interface which can, for example, allow a user of the apparatus 500 to specify particular settings relating to the security of files.

Each computing device 200, 300, 400 may receive information (e.g., security policies) from the apparatus 500. Each computing device 200, 300, 400 may also receive updates to the software entity that implements the agent from the central infrastructure apparatus 500. Each computing device 200, 300, 400 may also send information to the apparatus 500.

The computing devices 200, 300, 400 may implement different operating systems. For example, each computing device may implement one of the macOS, Windows or Linux operating systems.

Taking computing device 200 as example, computing device 200 implements a software entity in the form of an agent which monitors the computing device. The computing device 200 may implement a version of the agent suitable for the operating system running on the device 200. The agent, which acts as the local monitoring entity, monitors the device 200. The agent may monitor the operating system kernel on the device, and/or monitor the activity of applications (e.g., web browsers and email clients) running on the device.

The local monitoring agent is configured to determine whether to raise a security event in dependence on one or more security policies. Policies are configurable rules that can be used to raise sensors/alerts based on activity detected by the local monitoring entity (agent). The policies preferably comprise a specification of actions on a computing device supporting a local monitoring entity that that local monitoring entity should report to a remote monitoring entity. Policies may specify actions (e.g., the use of restricted administrative tools, sending sensitive information outside of the organization, circumventing security, accessing files, downloading data onto a Universal Serial Bus (USB) device, and printing documents during irregular hours). Events may therefore be detected based on security policies comprising a specification of actions on the data processing system that the local monitoring entity is to report to a remote monitoring entity. Policies may also specify one or more particular attributes of a file, for example, file content or a part thereof, properties or characteristics of the file (e.g., file type, file name etc.), or metadata associated with the file.

The policies may specify one or more actions. If the one or more actions are detected by the agent to have occurred at the device (i.e. if activity at the device meets one or more criteria specified by one or more policies), the agent can raise an event. The policies may be stored at the device 200. Activity of the device may be assessed against a set of one or more security policies and an event may be raised if the assessment meets one or more criteria. The criteria may be predefined criteria. For example, an event may be raised when a user performs an action for the first time, and/or performs an action outside of normal working hours. In some examples, the criteria may define an event. In other implementations, the criteria may be defined by parameters of a model (e.g., a machine learning or statistical model). The agent may raise an event when the output of the model, based on input to the model associated with activity at the device 200, indicates that an event should be raised. The model may be received from the central infrastructure apparatus 500. The model may be stored at the memory 202 of the device 200 and be accessible by the processor 201. The processor 201 may execute the model.

If one or more of the actions defined in one or more of the policies are detected as having occurred, the local monitoring entity can raise an event. Raised events can be reported to a remote monitoring entity. The remote monitoring entity may be implemented at the central infrastructure 500. The raising of the event indicates that the violation of a security policy has occurred. In response, the remote monitoring entity may raise an alert and/or log the violation, optionally along with the user identifier of the user that violated the policy. In response to an event being raised, the device 200 or the infrastructure 500 may generate a visible and/or audible alert, and/or may store data relating to the policy violation. This stored data can be accessed by a user (e.g., an administrator).

To assess activity at the device against a set of one or more criteria or policies, the agent can implement an assessment entity. In response to a determination that such an assessment meets one or more criteria, the assessment entity may cause the agent to perform a security action. For example, a security action may comprise one or more of storing a log of an event, reporting the activity to an entity external to the computer and causing operation of an application running on the computing device to be altered or blocked.

The criteria or policies may be received from another device (e.g., the central infrastructure apparatus 500). Updates to these criteria or policies may be made as appropriate.

As mentioned above, once events have been raised, they can be reported to an external entity (e.g., a remote monitoring entity), for example at central infrastructure 500. This may be performed by sending the events from the local device to the external entity via a network (e.g., the internet).

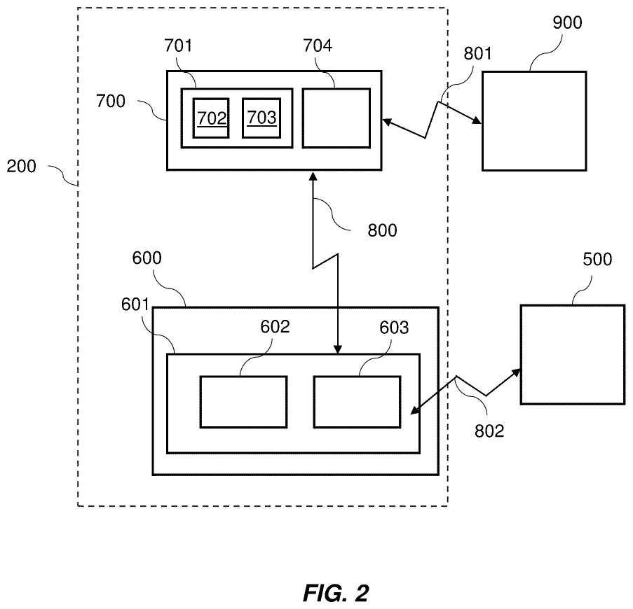

FIG. 2 schematically illustrates some further operational features of the computing device 200 as an example. As mentioned above, the device 200 may be configured to implement an agent, schematically illustrated at 600. The agent may operate as described above. The agent may implement application-level binaries and kernel/driver software.

The device 200 is also configured to implement an application. The application may be a user space application. In this example, the application in the form of a web browser, schematically illustrated at 700. The web browser may be, for example, Google Chrome, Mozilla Firefox, Apple Safari, Opera, Microsoft Internet Explorer or Microsoft Edge. The browser may be capable of implementing one or more browser extensions 701. The browser extension 701 may implement entities 702 and 703, which in this example are responsible for page content extraction and web activity monitoring respectively, which will be described in more detail below. Entity 704 is a cookie store for storing cookies. Cookies are data that the web server 900 generates and sends to the web browser 700. In this example, a single cookie store is shown. A browser may alternatively have multiple cookie stores and/or partition a cookie store (for example, for regular and incognito browsing).

The agent 600 and the browser 700 may have between them a communication channel 800. The communication channel 800 may allow the agent and the application to bidirectionally exchange information.

It may be desirable for a user of a computer device to be authenticated to a web service 900. The web service 900 may be a third-party service. The user may authenticate with the web service using web browser 700 implemented by the computing device 200. User authentication may be performed by providing credentials directly to the web service or to third party authentication server using an authentication protocol.

Login flows may require the user to provide credentials to authenticate themselves with the web service 900. These credentials may be provided directly to the service, as is the case of a form-based login, or to a third-party authentication server using an authentication protocol (e.g., Security Assertion Markup Language (SAML)), OAuth2, and Google Identity Services (GIS)). Often, particularly in the case of using an authentication server, the credentials do not need to be entered every time when logging in. However, the user may select the account they wish to use, and therefore the account context (e.g. username) may be displayed to the user. In another implementation, the account context may not be displayed to the user, but a token agreed with a third-party authentication server during a previous authentication (where the account context was displayed) may be used.

Hypertext Transfer Protocol (HTTP) requests can be made by the web browser 700 to third party websites to obtain content to display, including login forms and authorization login flows.

The agent 600 has a module, which may be within the application level binary, which is an assessment entity 601, which may also be referred to as a scripting engine or a policy engine. In some implementations, the assessment entity has access to a set of policies. The set of policies may comprise one or more policies. In some implementations, the assessment entity may receive new policies from an entity external to the computer and include those policies in the set of policies.

The assessment entity 601 may operate in a different execution environment to the web browser 700. The assessment entity may operate in its own execution environment. An execution environment may refer to the environment defined by an operating system for a block of executable code to run in. It may comprise a set of constraints/permissions imposed by the operating system on a specific application running on the computer. Those constraints may include restrictions on accessing areas of memory associated with other execution environments.

The assessment entity may communicate with an entity external to the computing device 200 (e.g., central infrastructure apparatus 500). A communication link between the assessment entity 601 and the remote entity 500 is shown at 802. The central infrastructure apparatus 500 may in some implementations be located at a cloud service.

In FIG. 2, the assessment entity 601 comprises an event analysis module 602 and a session tracking module 603. The event analysis module 602 may determine whether a security action should be performed based on information received from the web browser. The session tracking module 603 may track subsequent activity by a user to determine whether further security actions should be performed. These capabilities will be described in more detail below.

The agent 600 can monitor activity on the computing device it is running on, and activity events (file open, application open, TCP connection made etc.) can be run into the assessment entity 601. The activity is then run against a set of policy rules which look for particular things (e.g. TCP IP=“127.0.0.1”, application=“example.exe”) and if a rule is matched (which may be referred to as a detection), the security event is reported to the infrastructure apparatus 500. In this example, the assessment entity 601 is operable in a runtime environment of an operating system of the computer 200. In this example, the assessment entity is external to the web browser. The assessment entity may be dynamically updatable. In this example, the assessment entity 601 comprises a configurable scripting engine. The assessment entity may be in the same binary as the web browser, or may be communicatively connected to the web browser.

In other implementations, the assessment entity may not be located at the computer 200 itself. The assessment entity may be communicatively connected with the browser 700.

As mentioned above, the browser 700 can implement a browser extension 701. The browser extension 701 can perform functions (e.g., monitoring web activity, extracting web page content from the web browser, exposing an Application Programming Interface (API) to query Document Object Model (DOM) elements, reporting events (e.g., click and update) triggered on specific elements, and set cookies against a specified Uniform Resource Locator (URL)). In this example, the browser extension 701 implements entities 702 and 703, which can extract content from web pages viewed using the web browser and monitor web activity by the user respectively.

The assessment entity 601 may signal to the web browser 700 to send content from one or more web pages visited using the web browser to the assessment entity. The assessment entity may indicate to the web browser content and/or events of interest from web pages visited using the web browser that are to be reported to the assessment entity.

Browser events (for example, websites visited, redirects, uploaded files, downloaded files, text copied into input fields, etc.) can also be fed from the browser extension 701 back into the agent along the communication channel 800, and into the assessment entity 601 at the agent 600.

In this example, the scripting engine at the agent can control the browser extension's functionality and/or correlate reported information to detect a successful user authentication and track subsequent activity at the web browser, as will be described in more detail below. The scripting engine can also configure the browser extension 701 to report when Document Object Model (DOM) elements with specific attributes are added or interacted with.

In the system described herein, a computing device may utilize the browser, in particular the browser extension 701, to observe one or more updates to the state of the web browser 700. For example, updates to stored data (e.g., cookies) added or modified by a web server during the authentication process for a user can be observed and reported to the assessment entity. The browser extension 701 can determine one or more updates to a state of the web browser and report the one or more updates to the state of the web browser to the assessment entity 601. This may allow the assessment entity to identify the scope (e.g. which web services) of the authentication, and/or associate subsequent activity with the authenticated account.

The assessment entity 601 can process the received one or more updates to the state of the web browser to identify a context of the user authentication. For example, the assessment entity may determine a username of the user that is the subject of the authentication from the one or more updates to the state of the web browser. The assessment entity may also determine which web services the user that is the subject of the authentication is using.

The one or more updates to the state of the web browser may comprise one or more of an addition to or modification of data stored at the web browser. The one or more updates to the state of the web browser may be made in dependence on one or more responses from the web service to the web browser. In some examples, the stored data comprises one or more cookies. The data may be stored locally at the web browser, for example in cookie store 704. The browser 700 can, for example, update the cookie store 704 using Set-Cookie headers from web server HTTP responses.

As mentioned above, a browser may have multiple cookie stores and/or partition a cookie store such that the browser can provide multiple profiles by reporting state updates for each cookie store or part thereof to the assessment entity (for example, for different browsers modes (e.g., regular and incognito browsing)).

The one or more updates to the state of the web browser may alternatively or additionally comprise one or more updates to ephemeral information/state in the random access memory (RAM) of the computing device 200. Updates to rendered HTML may be observed to indicate an update to the state of the web browser. Such updates to rendered HTML are typically made by web requests to a server and/or by client side JavaScript (which may be performed by clicking on buttons and/or typing text into an input box) which is generally ephemeral and unlikely to be stored to disk. Rendered HTML can be inspected for content. Updates to rendered HTML can be reported to the assessment entity. Event listeners can be attached to elements of interest. Content and events of interest are then reported to the assessment entity 601.

The browser extension 701 may be configured to use attributes of the HTML to identify and extract this information. This configuration can be dynamically controlled by the scripting engine, allowing changes in authentication flow to be handled without code changes to the browser or extension.

In some implementations, the assessment entity 601 may have knowledge of authorization flows at the web browser. The assessment entity may correlate received information from multiple web server requests to identify a completed user authentication.

Once the user authentication is complete, the assessment entity can track user activity during an authenticated user session. The assessment entity can track subsequent activity by the user that is the subject of the user authentication. Subsequently web activity can be reported to the assessment entity and annotated by the web browser with information indicative of the user that is the subject of the user authentication. This may be performed by the entity 703. The assessment entity 601 may process the information indicative of the user to obtain user state information corresponding to the web activity.

In some implementations, the browser may annotate the web activity directly with the username of the user that is the subject of the authentication. In other implementations, the information indicative of the user that is the subject of the user authentication may comprise a tracking token. The web activity may be annotated with the tracking token. The token may be used by the assessment entity to look up information about the user.

In one implementation, the tracking token is a tracking cookie. The tracking cookie may, for example, be scoped to the same domain and/or cookie store 704 as used by the web browser 700 for the user authentication. Subsequent web activity can be reported to the assessment entity by the browser extension, annotated with the tracking cookie, so that user context may be obtained. The tracking token may have other forms.

Once authentication is complete, a shared token can be included in all subsequent requests to the server to identify the user, rather than providing credentials. The token is scoped by the web server to provide access to a set of domains, subdomains, and URL paths, and is typically exchanged and stored by the browser as a cookie in its cookie store. The system described herein observes the cookies set by the web service 900 as part of the authentication process in order to identify the scope (domain) the user's credentials apply to.

The browser may maintain multiple cookie stores for different browsing modes, for example private/incognito mode, and different users on the machine. In doing so, users may be logged into the same website with different credentials at the same time by using a mix of browsing modes. The system described herein can identify the cookie store used for the authentication, and so is able to identify the browser, profile, and browsing mode that the user's credentials apply to.

With this information, the system can then insert its own tracking cookie, which can be scoped to the same domain and cookie store. On any subsequent activity by the user, the tracking cookie may be used to recall saved state about the user (e.g., their username).

The assessment entity may be configured to filter updates to the state of the web browser reported by the web browser to determine one or more updates related to the user authentication. In some implementations, the assessment entity may filter cookies reported by the web browser to determine one or more cookies related to the user authentication in dependence on one or more properties of the cookie. For example, the one or more properties of the cookie may comprise one or more of the http only, secure, session, expiration date, name and value of the cookie.

The assessment entity 601 can assess the one or more updates to the state of the web browser against one or more criteria, for example one or more security policies, and, in response to a determination that such an assessment meets one or more of the criteria, perform a security action. The security action may comprise one or more of the following: transmitting an alert to an entity external to the computer (e.g., a remote monitoring entity at infrastructure apparatus 500) storing a log of an event and blocking an activity of the application. For example, where the application is a web browser, the security action may comprise blocking operation of the browser. This may prevent a user from accessing a website that could pose a security risk. The security action may alternatively or additionally comprise preventing one or more files from being uploaded to and/or downloaded from the website.

In some implementations, the policy assessment entity 601 is further configured to, in response to a determination that an assessment of that activity against the set of one or more policies meets one or more criteria, transmit an indication of a predetermined form to an entity external to the computer, for example central infrastructure apparatus 500.

In some implementations, the computer 200 may be associated with a corporate network. For example, the computer may be able to connect directly or via an entity (e.g., a virtual private network (VPN)) to the corporate network. The assessment entity may perform a security action if it is determined from the one or more updates to the state of the web browser that non-corporate credentials have been used for the user authentication. As used herein, “non-corporate” credentials are credentials that do not relate to the same corporate entity as has the corporate network. For example, corporate credentials may comprise one or more of an email address, username or other identifier, and password of an employee of the corporate entity. The employee may use the computer associated with the corporate network. Non-corporate credentials may comprise one or more of an email address, username or other identifier (e.g., a personal email address) that is not associated with the corporate entity.

Some examples of how the context of the user authentication may be determined in dependence on the one or more updates to the state of the web browser will now be described. Other implementations are also possible.

A first example will now be described where a form-based login is used to perform the user authentication.

The assessment entity 601 may configure the browser extension to report when <input> elements with given attributes are updated by the user. For example, the assessment entity 601 may request to be informed when the value of an input element with any of the following attributes is changed; type=text or password or email, placeholder=email or username, autocomplete=username or email, name=email or username or login.

When a user uses the browser to navigate to a login page for a website which requires user authentication, the server provides the HTML to render a login form containing <input>fields for the username and password associated with the user that is the subject of the authentication.

In one implementation, the browser extension 701 can use, for example, JavaScript APIs to add event listeners to the <input> fields. The browser extension 701 can report the entered values to the assessment entity 601 if they match the attributes that are to be reported to the assessment entity 601 (as previously configured by the assessment entity).

When the user enters their username and password for the user authentication, the event listeners can observe the entered values and report them to the assessment entity 601. The event listeners can also report attributes of the <input> field and/or the website URL to the assessment entity 601. The assessment entity 601 can record these values.

The browser can transmit the values to the server as a web POST request triggered by a submit button or JavaScript observing input change. The browser extension 701 can report the web request to the assessment entity 601, which confirms the entered credentials are present in the request (i.e. confirms that the request is attempting authentication).

In another example, a SAML-based login is used to authenticate the user.

A user uses the browser 700 to navigate to a web service login page. The server 900 redirects the browser to a SAML identity provider's server.

The browser 700 relays the SAML request to the identity provider's server, where authentication may occur untracked by the browser extension 701 associated with the assessment entity 601. The identity provider provides a SAML assertion back to the browser. The browser may relay the SAML assertion to the web service as a web request containing an XML encoded SAML response.

The browser extension 701 reports the web request to the assessment entity 601. The assessment entity parses the XML response and extracts the NameID representing the username of the authenticated user to determine the context of the user authentication.

In a further example, a Google OAuth2.0-based login is used to authenticate the user.

The assessment entity 601 may configure the browser extension to report when <div> elements with attribute “data-identifier” are added to the DOM on pages with specific URLs e.g. https://accounts.google.com/o/oauth2/auth/oauthchooseaccount.

A user uses the browser 700 to navigate to a login page for a website. The server provides the HTML to render a login, which may be provided with a Google button. The user clicks the login button, causing the browser to navigate to Google's OAuth page. The browser extension reports the web navigation to the assessment entity 601. The assessment entity parses the URL and extracts a redirect URL encoded in the query parameters. The redirect URL is recorded by the assessment entity. Google's server provides the HTML, JavaScript and CSS to render a “Choose an account” page. The browser extension uses JavaScript APIs to add a MutationObserver to monitor for DOM changes.

Additional web requests are made by the browser to obtain further information needed to render the page, resulting in <div> elements being added. <div> elements with the attribute “data-identifier” are reported to the assessment entity.

The assessment entity 601 parses the <div> elements to extract the “data-authuser” (representing a Google controlled ID for the user) and “data-identifier” (representing the email address) attributes of the element. A set of these are recorded by the assessment entity.

The user selects the desired account, resulting in a web request to Google's server. The request is reported by the browser extension 701 to the assessment entity 601. The assessment entity 601 parses the request URL and extracts the query parameter “authuser”, which corresponds to the “data-authuser” attribute recorded previously, and by proxy the corresponding “data-identifier” representing the selected email address.

The authentication flow continues, resulting in a redirect back to the web services URL as provided in the initial request to Google, and recorded by the assessment entity. The redirect is reported by the browser extension 701 to the assessment entity 601, which concludes the authentication detection.

To determine which web services the user authentication relates to, the following may be performed. Other implementations are possible.

The authentication flow completes as described above. The authentication process finishes back at the web service that the user authentication relates to.

The browser extension 701 may use JavaScript APIs to obtain the cookie store in use by the web browser and the tab displaying the web page. The cookies set by the server can be extracted from the appropriate cookie store using the URL currently being displayed. The cookies can then be filtered.

In this example, the cookies are first filtered by their “httpOnly” and “secure” status. General security practices may dictate authentication tokens should be set as such. Cookie values are filtered to remove those unlikely to be authentication tokens (i.e. cookies that are unrelated to the user authentication). Authentication tokens are typically alpha numeric values of reasonable length. Therefore, the cookies may be filtered to remove those that are not related to the user authentication by removing cookies having a length less than a predetermined threshold. Optionally, cookies may be filtered to result in those that were added or modified by the server between the time of the authentication starting and concluding. The filtered cookies can then be grouped by the domain and/or path they apply to. The largest group of cookies can be selected as the scope (i.e. the web service) to associate with the user authentication. The web service associated with the user authentication can therefore be determined in dependence on the one or more updates to the state of the web browser-in this case, in dependence on one or more cookies stored at the web browser.

A tracking cookie can be inserted by the browser extension into the same cookie store using the domain and path identified by the previous step. This tracking cookie can then be reported by the browser extension to the assessment entity for any subsequent web activity that the tracking cookie applies to.

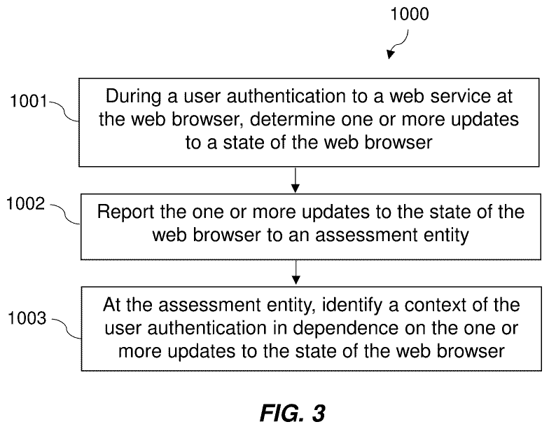

FIG. 3 shows the steps of an exemplary method 1000 for implementation at a computer capable of implementing a web browser. At step 1001, the method comprises, during a user authentication to a web service at the web browser, determining one or more updates to a state of the web browser. At step 1002, the method comprises reporting the one or more updates to the state of the web browser to an assessment entity. At step 1003, the method comprises, at the assessment entity, identifying a context of the user authentication in dependence on the one or more updates to the state of the web browser.

The approach described herein may assist in preventing malicious activities from occurring by alerting on suspicious behavior involving users participating in authenticated user sessions and in response, the local computing devices may block activities at applications. This may improve cyber hygiene and keep data and endpoints secure, regardless of location (for example, whether the user is in the office or working remotely) and network connection (for example, public Wi-Fi or VPN). This may provide improved endpoint security, as well as visibility into user behavior, data access, and system use. Furthermore, tracking which account is currently authenticated with a web service may allow to fully protect data moving to unauthorized web services. This approach provides a technique for tracking the activity of a user after they log into a third-party website, providing the ability to associate web activity (e.g., file uploads and downloads) with a user account.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description it will be evident to a person skilled in the art that various modifications may be made within the scope of the present disclosure.

What is claimed is:

1. A non-transitory machine-readable medium storing instructions, which when executed by one or more processors of a computing device, cause the computing device to:
during a user authentication to a web service at a web browser, determine one or more updates to a state of the web browser;
report the one or more updates to the state of the web browser to an assessment entity; and
at the assessment entity, identify a context of the user authentication based on the one or more updates to the state of the web browser.

2. The non-transitory machine-readable medium of claim 1, wherein the assessment entity is external to the web browser.

3. The non-transitory machine-readable medium of claim 1, wherein the one or more updates to the state of the web browser are made in dependence on one or more responses from the web service to the web browser.

4. The non-transitory machine-readable medium of claim 1, wherein the context comprises a username of a user that is a subject of the user authentication.

5. The non-transitory machine-readable medium of claim 1, wherein the one or more updates to the state of the web browser comprise one or more of an addition to or modification of one or more cookies stored by the web browser.

6. The non-transitory machine-readable medium of claim 5, wherein the instructions further cause the assessment entity to filter cookies reported by the web browser to determine one or more cookies related to the user authentication based on one or more properties of the cookie.

7. The non-transitory machine-readable medium of claim 1, wherein the assessment entity is dynamically updatable.

8. The non-transitory machine-readable medium of claim 1, wherein the instructions further cause the assessment entity to:
assess the one or more updates to the state of the web browser against one or more criteria; and
after a determination that the assessment meets one or more of the criteria, perform a security action.

9. The non-transitory machine-readable medium of claim 8, wherein the instructions further cause the assessment entity to assess the updates to the state of the web browser against one or more security policies.

10. The non-transitory machine-readable medium of claim 8, wherein the security action comprises one or more of storing a log of an event, reporting the activity to an entity external to the computer device and causing operation of the web browser to be altered or blocked.

11. The non-transitory machine-readable medium of claim 8, wherein the computer device is associated with a corporate network and wherein the instructions further cause the assessment entity to perform a security action based on a determination that non-corporate credentials have been used for the user authentication.

12. The non-transitory machine-readable medium of claim 1, wherein the web browser is capable of invoking one or more web browser extensions to monitor web activity and extract web page content from the web browser.

13. The non-transitory machine-readable medium of claim 12, wherein the assessment entity comprises a scripting engine operable to perform one or more of: controlling functionality of the one or more web browser extensions, correlating reported information to detect a successful user authentication and tracking subsequent activity of the web browser.

14. The non-transitory machine-readable medium of claim 1, wherein user authentication is performed using a form-based login providing credentials directly to the web service or to a third party authentication server using an authentication protocol.

15. The non-transitory machine-readable medium of claim 1, wherein the instructions further cause the assessment entity to track subsequent activity by a user that is a subject of the user authentication, wherein the web browser is configured to annotate web activity by the user with a tracking token.

16. The non-transitory machine-readable medium of claim 15, wherein the tracking token comprises a tracking cookie and wherein the tracking cookie is scoped to a same domain and cookie store as used by the web browser for the user authentication.

17. The non-transitory machine-readable medium of claim 16, wherein the instructions further cause the assessment entity to analyze subsequent web activity annotated with the information indicative of a user that is the subject of the user authentication to obtain user state information corresponding to the web activity.

18. The non-transitory machine-readable medium of claim 1, wherein the instructions further cause the web browser to send content from one or more web pages visited using the web browser to the assessment entity.

19. A computer-implemented method for use at a computer capable of implementing a web browser, the method comprising:
during a user authentication to a web service at the web browser, determining one or more updates to a state of the web browser;
reporting the one or more updates to the state of the web browser to an assessment entity; and
at the assessment entity, identifying a context of the user authentication based on the one or more updates to the state of the web browser.

20. A computing device comprising:
one or more processors; and
instructions that when executed by the one or more processors cause the computing device to:
during a user authentication to a web service at a web browser, determine one or more updates to a state of the web browser;
report the one or more updates to the state of the web browser to an assessment entity; and
at the assessment entity, identify a context of the user authentication based on the one or more updates to the state of the web browser.
